(19) United States
(12) Patent Application Publication
(10) Pub. No.: US 2013/0178168 A1
(43) Pub. Date: Jul. 11, 2013

(54) Multi-Band Matching Network for RF Power Amplifiers

(71) Applicants: Chunjie DUAN, Brookline, MA (US); Xi LONG, Newark, DE (US); Koon Hoo TEO, Lexington, MA (US)

(72) Inventors: Chunjie DUAN, Brookline, MA (US); Xi LONG, Newark, DE (US); Koon Hoo TEO, Lexington, MA (US)

(21) Appl. No.: 13/347,385

(22) Filed: Jan. 10, 2012

(51) Int. Cl. H04B 1/38

(52) U.S. Cl. 455/73

(57) ABSTRACT

A multi-band matching network for RF power amplifiers utilizes multiple impedance transformer branches connected in parallel. Each transformer branch achieves matching at one frequency band. A core of each transformer branch is connected between frequency blocking networks, which reject out-of-band signals.

### FIELD OF THE INVENTION

This invention relates to power amplifiers, and more particularly to radio frequency (RF) power amplifiers with multi-band matching for wireless transceivers used in cellular and other wireless networks.

### BACKGROUND OF THE INVENTION

The advancement of wireless communication networks has necessitated the need for mobile transceivers (terminals or user equipment (UE)) capable of multi-band operation. For example, the Global System for Mobile Communications (GSM), which accounts for 60% of the global mobile telephone market in 2010, had only the 900 MHz band available when introduced. A few years later, the Digital Cellular Service (DCS) band (1.8 GHz) was added. These bands are used in Asia and Europe. In the U.S., the Personal Communications Service (PCS) band (1.9 GHz) and the 850 MHz band were adopted. As a result, the GSM system currently spans four bands.

The 3rd Generation Partnership Project (3GPP), Long Term Evolution (LTE) is the next advance in mobile communication to cope the overwhelming increase in the data traffic resulted from applications such as online gaming, mobile TV, and multimedia streaming. The main targets for LTE are an enhanced data rate, an increased spectral efficiency, and a reduced latency. There are more than 30 bands defined for LTE according to 3GPP Rel.10. The main bands of interest for North America are bands 13 and 14 (700 MHz bands) and band 4 (1710 to 1755 MHz). In Europe, band 7 is expected to be widely used, with operation from 2500 to 2570 MHz. In Japan, it is likely that band 1 (1920 to 1980 MHz) will be used first for LTE.

To achieve seamless operation among the networks worldwide, mobile terminals with multi-band operation capability are required. A radio frequency (RF) power amplifier (PA) is one of the key components in mobile terminals. It is difficult for the PA to achieve high output power and high power efficiency concurrently over multiple bands.

Several approaches that address this issue are known. One approach is based on a parallel line-up of single-band PA. The PA corresponding to the frequency band is selected via an array of switches. That approach heeds as many PAs as the number of the operation frequency bands, which increases the size and cost of the terminal.

Another approach uses a multi-band matching network (MN). Several MN configurations are available. Broadband MN can achieve a wide frequency operation range. However, it is difficult to achieve high power efficiency over a broad frequency range because the output characteristics of the PA vary over frequency. Reconfigurable MNs use RF switches. Variable devices can also address this issue. However, the addition of RF switches or variable devices degrades the system performance and/or reliability. RF switches suffer from insertion loss and limited isolation. Variable devices such as varactor have a limited quality factor, and may require high tuning voltage.

It is therefore desirable to have a PA with multi-band operation capability with a MN composed of only passive devices.

### SUMMARY OF THE INVENTION

The embodiments of the invention provide a multi-band matching network for RF power amplifiers that utilize multiple impedance transformer branches connected in parallel. Each transformer branch achieves matching at one frequency band.

The core of each transformer branch is connected between frequency blocking networks, which reject out-of-band signals. The resulting matching network can achieve an optimal impedance match between the load and the output of the amplifier simultaneously at different frequency bands. Tuning or switching elements, which are inevitably lossy as in the prior art, are not used.

Specifically, a multi-band matching network (MN) includes a set of impedance transformer branches connected in parallel. Each transformer branch includes an L-shaped LC MN that is optimized for one of the required operation frequency bands. Frequency blocking networks are added before and after each LC MN core to prevent interference between each other. The MN offers optimal impedance matching for the PA at multiple frequency bands simultaneously, without using any active tuning or switching elements.

The MN for a triple-band PA works at LTE bands of 700 MHz, 1.7 GHz, and 2.6 GHz. The MN is designed and to achieve over 40% maximal power added efficiency (PAE) with a peak output power exceeding 28 dBm, and can be used in a last RF PA stage of multi-band terminals.

### BRIEF DESCRIPTION OF THE DRAWINGS

FIG. 1 is a schematic of a matching network (MN) for a multi-band power amplifier in mobile terminals according to embodiments of the invention;

FIG. 2 is a detailed schematic of an impedance transforming branch for a multi-band MN according to embodiments of the invention;

FIG. 3A-3B are schematics of example L-shaped MN cores according to embodiments of the invention; and

FIG. 4 is a graph of power gain and S₂₁ as a function of frequency.

### DETAILED DESCRIPTION OF THE PREFERRED EMBODIMENT

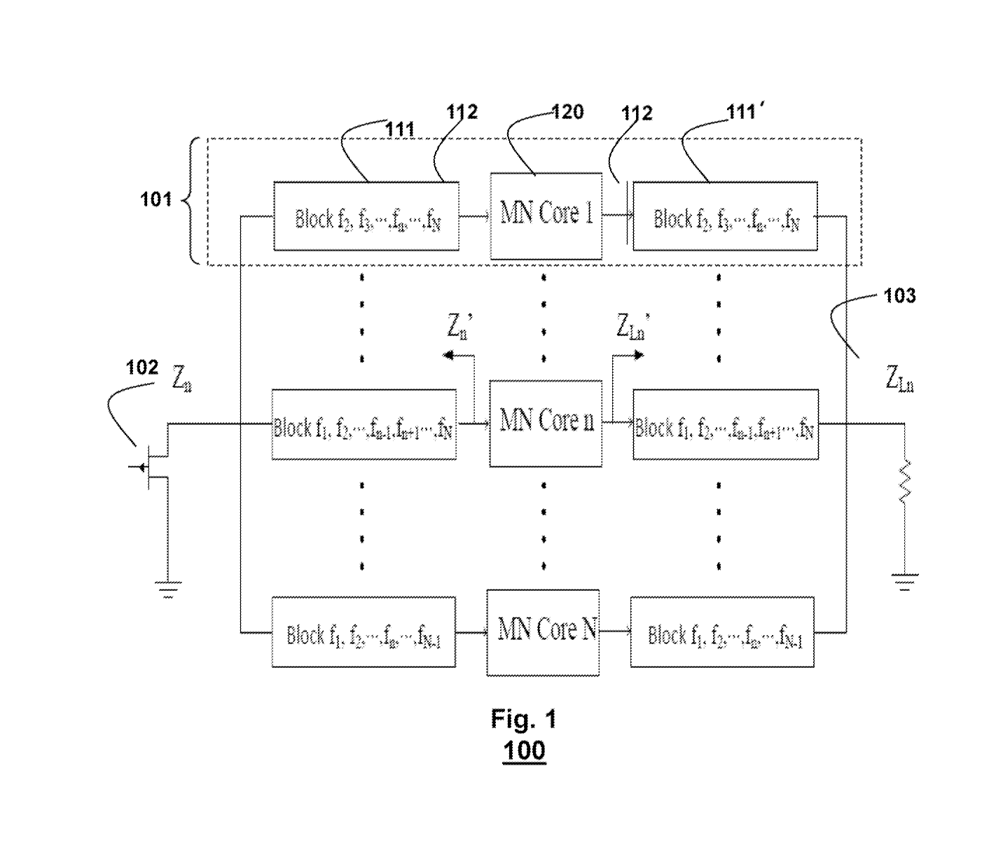

FIG. 1 shows a matching network (MN) 100 for a multi-band power amplifier (PA) in mobile terminals (transceivers) according to embodiments of the invention. The MN can be used in either a transmitter or a receiver of a transceiver (mobile terminal), or both. The purpose of the MN is to match an output impedance of a RF source, e.g., a power amplifier, to an input impedance of a load to maximize the power transfer and/or minimize reflections from the load.

The multiband MN includes a set of N branches 101 of impedance transformers connected in parallel, where N denotes the number of operation frequency band signals. At an input port 102 of the MN 100, an impedance at an output of the multi-band PS amplifier output is Zₙ for band n, and at an output port 103, an impedance of the load for band n is Z_{Ln}.

For each n^{th} branch, there is a first N−1 frequency blocking element 111 before each n^{th} MN core 120, and a second N−1 frequency blocking element 111 after each n^{th} MN core 120. That is, the MN core is connected in series between the first and second frequency blocking elements.

The frequency blocking elements reject out-of-band frequencies from both the amplifier output and the load to avoid impedance deviation caused by other parallel transformer branches. For the n^{th} frequency band, the output of the amplifier is for the n^{th} branch of the MN, while all the other parallel branches appear as an open circuit at the output port 103. The same holds for the input.

As a result, all the other branches can be neglected at the frequency band under analysis. The frequency blocking elements before the core transform the impedance Zₙ to Z_{n′}, while the frequency blocking elements after the core transform the load impedance from Z_{Ln} to Z_{Ln′}.

The MN core n conjugately matches Zₙ to Z_{n′}. Therefore, an optimal matching is achieved at the n^{th} frequency band. The same analysis applies to other branches. The overall MN simultaneously achieves optimal matching at the set of N frequency bands.

Example Circuit

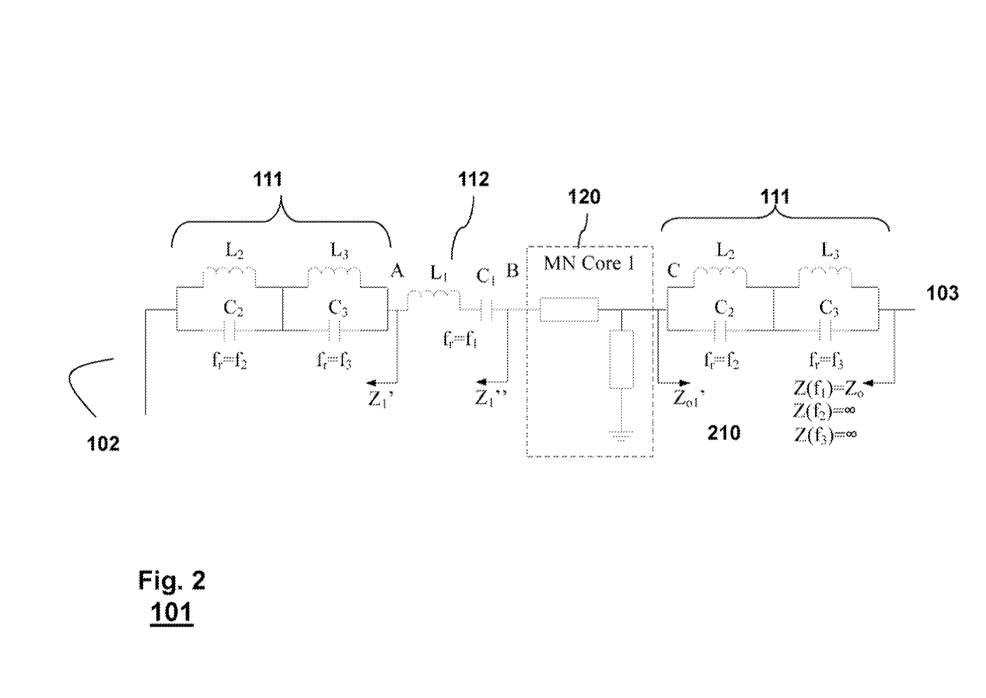

FIG. 2 shows an example of one impedance transformer of a tri-band MN branch 101 according to embodiments of the invention. Other branches can be implemented with the similar circuit.

The frequency blocking element includes two LC networks 111 connected to either side of the MN core 120. The center frequencies of the three operations bands are denoted as f₁, f₂, and f₃ respectively. L₁ and Cₙ resonates at a frequency fₙ. At this resonance frequency, the serial connected LC network appears as an open circuit. For simplicity reason, the load impedance is selected to be the same impedance Z₀ for all operation frequency bands. At frequency f₁, the optimal output impedance of the amplifier is Z₁. The frequency components of band 1 are blocked by L₁C₁ network. As a result, the second and the third transformer branches appear as an open circuit to both the amplifier output and the load. The frequency components of band 1 are able to pass through the L₂C₂ network and the L₃C₃ network. However, L₂C₂ and L₃C₃ transforms the output impedance of the amplifier from Z₁ to impedance Z_{1′}, whereas the load impedance is transformed from Z₀ to Z_{01′}.

The LC networks 111 can be followed, or preceded by LC circuits 112. The circuits suppresses out-of-band frequencies, e.g., Z(f₁)=0, and Z(f≠fᵢ)=∞.

The MN core 1 between the LC networks, which is an L-shaped LC matching network, conjugately matches Z_{1′} to Z_{o1′} to achieve maximal power transfer between the output and the load. The same analysis applies to the other branches, which operate at frequencies f₂ and f₃, respectively.

The parallel connection of the three transformer branches results in a triple band MN that optimally matches the load impedance to the amplifier output at three operation bands simultaneously without any tuning or switching elements.

Design of Triple-Band PA

A triple-band PA operates at 700 MHz, 1.7 GHz, and 2.6 GHz bands. The field effect transistor (FET) at the input port 102 is a high electron mobility transistor (HEMT). The HEMT can deliver 30 dBm output power with 14.8 dB gain at 2 GHz and a supply voltage of 4.5 V. The PA is designed to operate in class AB mode as known in the art. That is two active elements conduct more than half of the time as a means to reduce the cross-over distortions of class-B amplifiers.

After setting the DC bias, load pull and source pull simulation is performed at each of the three frequency bands to find the optimal load and source impedance.

In load pull, a variable AC load is connected to the output of the FET directly. The load impedance is swept over the whole Smith chart. The corresponding output power and power added efficiency (PAE) are measured at each point and corresponding contours are generated. The optimal load impedance at each frequency band is determined based on the output power and PAE simulation results, as shown in Table I (normalized to Z₀).

TABLE I
OPTIMUM LOAD IMPEDANCE FOR THE
THREE BANDS (NORMALIZED)

| Z₁* | Z₂* | Z₃* |
|---|---|---|
| 0.236 − 0.388j | 0.321 − 0.667j | 0.248 + 0.429j |

The source side is less sensitive to frequency variation according to source pull simulation. The source impedance is set to 0.11-0.11j for all the three frequency bands. This has minimum impact on the amplifier's power transfer characteristics.

The next step is to determine the LC value of the LC circuits that are used as frequency blocking elements. The LC circuits affect the bandwidth of the overall system. The following equation dictates the relationship among fᵣ, L and C

$${f}_{r} = \frac{1}{2 π \sqrt{LC}} . \qquad ( 1 )$$

When L₁, L₁ and L₃ are all set to 2 nH, the value of C₁, C₂ and C₃ are 1.87 pF, 4.38 pF and 25.9 pF, respectively. After the LC value of the LC circuits is determined, we can determine Z_{n′} and Z_{on′} based on Zn and Zₒₙ using the Smith chart.

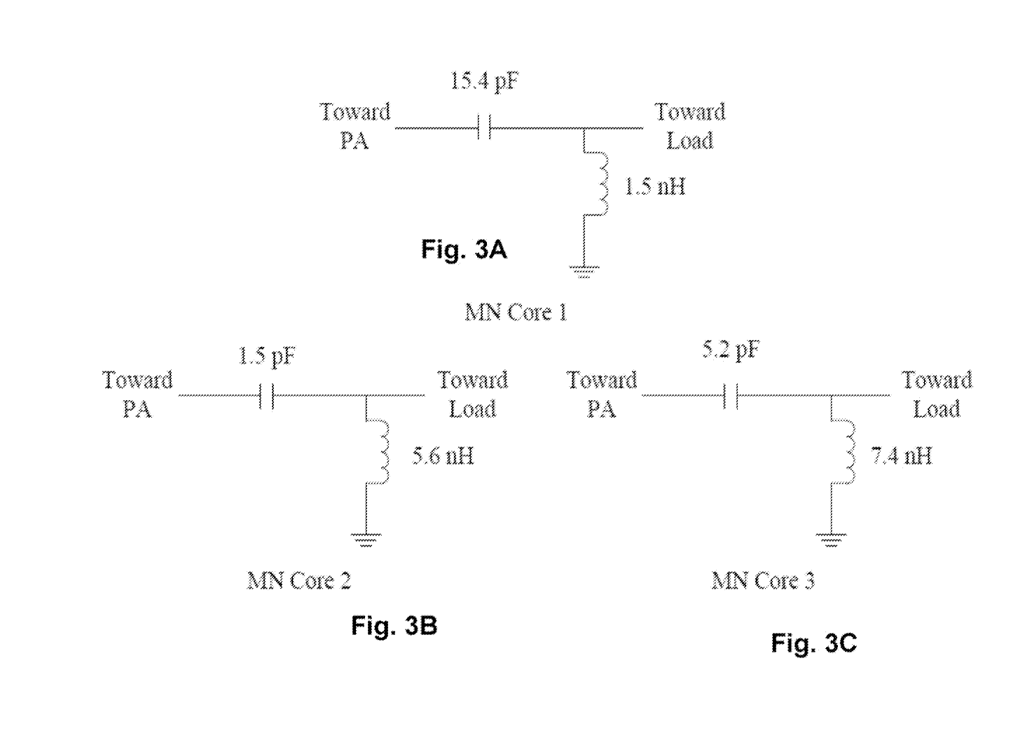

Example L-shaped MN core are shown in FIGS. 3A-3B. More complicated topologies such as π or T-shaped MN can also be used. The selection of MN topology affects the amplifier's bandwidth. We select L-shaped for simplicity reason.

Triple-Band PA Simulation

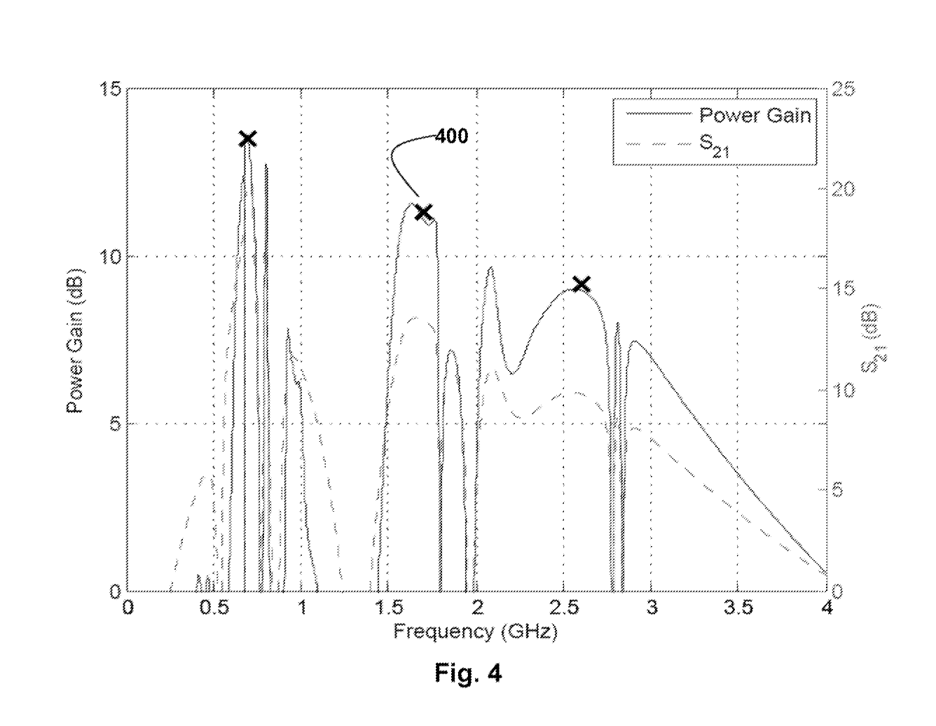

Large signal and small signal frequency response based simulation are shown in FIG. 4, with power gain and S₂₁ versus frequency; ×400 denotes maximal achievable power gain for three frequencies. In addition to S parameter simulation, large signal analysis based on harmonic balance simulation is used to account for the nonlinearity resulted from high power operation.

The three peaks at 0.7 GHz, 1.7 GHz and 2.6 GHz exist in both the power gain and S₂₁. This PA achieves 13.4 dB, 11.2 dB, and 8.7 dB power gain at operations bands of 0.7 GHz, 1.7 GHz, and 2.6 GHz, respectively. The decrease of power gain as frequency increases is due to the intrinsic S₂₁ degradation of the FET at higher frequencies. The maximal power gain achievable at each frequency bands shown in FIG. 4 is based on load pull simulation results. Additional peaks appear between the targeted frequency bands. Because the goal is to achieve optimal matching at desired frequency bands, the out-of-band gain does not matter as long as the PA stays in a stable region.

### EFFECT OF THE INVENTION

The invention provides simultaneous multi-band matching for RF power amplifier (PA) without the integration of any tuning or switching elements. The PA shows a peak output power greater than 28 dBm and a maximal PAE greater than 40% at three operation frequency bands. This circuit can amplify signals from multi-bands simultaneously.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. An apparatus in a form of an impedance matching network (MN) for a multiband power amplifier, comprising:
an input port configured to receive a set N of frequency band signals from a radio frequency (RF) amplifier;
an output port configured to output a set of N frequency band signals;
a set of N transformer branches connect in parallel between the input port and the output port, wherein each transformer branch matches at one frequency band, and further comprising:
a first frequency blocking element to block frequencies other than frequency band fₙ at the input port to the MN;
a second frequency blocking element to block frequencies other than frequency band fₙ; and
a MN core connected between the first frequency blocking element and the second frequency blocking element to conjugately match impedances Zₙ to Z_{Ln}, and to achieve a maximal power transfer between the input port and the output port, and wherein each transformer branch rejects out-of-band frequencies at the input port and the output port to avoid to avoid impedance deviation caused by other branches.

2. The apparatus of claim 1, wherein each transformer branch rejects out-of-band signals, and minimizes reflections from a load.

3. The apparatus of claim 1, further comprising:
a multi-band terminal with the apparatus as a last RF power amplifier stage.

4. The apparatus of claim 1, wherein the frequency blocking element includes N−1 LC networks connected serially to either side of the MN core.

5. The apparatus of claim 4, wherein center frequencies of N operations bands are denoted as f₁, f₂, and f_{N} respectively, and Lₙ and Cₙ of the LC networks resonates at a frequency fₙ.

6. The apparatus of claim 4, wherein the serial connected LC network appears as an open circuit.
